(19) United States
(12) Patent Application Publication
(10) Pub. No.: US 2022/0134150 A1
(43) Pub. Date: May 5, 2022

(54) SAFETY HARNESS CONNECTOR ASSEMBLY

(71) Applicant: CHECKMATE LIFTING & SAFETY LTD, Kent (GB)

(72) Inventor: Oliver AUSTON, Faversham (GB)

(73) Assignee: CHECKMATE LIFTING & SAFETY LTD, Kent (GB)

(21) Appl. No.: 17/509,395

(22) Filed: Oct. 25, 2021

Related U.S. Application Data
(60) Provisional application No. 63/107,623, filed on Oct. 30, 2020.

(51) Int. Cl. A62B 35/00; F16B 13/00

(52) U.S. Cl. CPC A62B 35/0037; F16B 13/00

(57) ABSTRACT

A safety harness connector assembly comprises a strap connector and an insert. The strap connector includes a base through which a base bore longitudinally extends and an extension. The base and the extension form an opening configured and arranged to receive a strap of a safety harness. The insert includes an intermediate portion interconnecting a first side and a second side, and the intermediate portion is configured and arranged to be received within the base bore. The first side includes a protrusion and the second side includes a shoulder portion. The protrusion and the shoulder portion are configured and arranged to engage opposing ends of the base when the intermediate portion is received within the base bore to secure the insert within the base.

### CROSS REFERENCE TO RELATED APPLICATIONS

This application claims the benefit of U.S. Provisional Patent Application Ser. No. 63/107,623, filed Oct. 30, 2020, which is incorporated by reference herein.

### BACKGROUND

Fall protection equipment is commonly used to reduce a likelihood of a fall and/or injuries associated with a fall, particularly by users who perform tasks at heights or are at risk of falling. Generally, lifelines or lanyards typically interconnect anchorage structures and safety harnesses donned by users. The lifelines or lanyards allow the users to move and perform tasks while being connected to the anchorage structures. Should a user fall, the lifeline or lanyard limits the distance the user falls and forces exerted upon the user.

A user commonly connects a lifeline or a lanyard to the strap(s) of the safety harness, for example via a D-ring proximate a dorsal pad assembly positioned on the back of the user's safety harness. To connect the lifeline or lanyard to the safety harness, it is desirable to have a connector operatively connected to the safety harness that could accommodate different types of lifelines and lanyards, which include a variety of different types of connectors such as carabiners, snap hooks, dual self-retracting lifeline connectors, etc.

For the reasons stated above and for other reasons stated below, which will become apparent to those skilled in the art upon reading and understanding the present specification, a need exists for the present invention.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a safety harness connector assembly comprises a strap connector and an insert. The strap connector includes a base through which a base bore longitudinally extends and an extension. The base and the extension form an opening configured and arranged to receive a strap of a safety harness. The insert includes an intermediate portion interconnecting a first side and a second side, and the intermediate portion is configured and arranged to be received within the base bore. The first side includes a protrusion and the second side includes a shoulder portion. The protrusion and the shoulder portion are configured and arranged to engage opposing ends of the base when the intermediate portion is received within the base bore to secure the insert within the base.

In one embodiment, a safety harness comprises a strap forming at least a portion of the safety harness and a strap connector. The strap connector includes a base through which a base bore longitudinally extends and an extension extending laterally outward from a top of the base. The base and the extension form an opening through which the strap extends. The top of the base is longer in length than a bottom of the base and forms a first angled end surface and a second angled end surface. The first angled end surface forms a first angled opening into the base bore and the second angled end surface forms a second angled opening into the base bore.

In one embodiment, an insert for use with a strap connector having a base with a base bore comprises an intermediate portion interconnecting a first side and a second side. The intermediate portion is configured and arranged to be received within the base bore. The first side includes a protrusion and the second side includes a shoulder portion, the protrusion and the shoulder portion are configured and arranged to engage opposing ends of the base when the intermediate portion is received within the base bore to secure the insert within the base.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a front trimetric view of a safety harness connector assembly constructed in accordance with the principles of the present invention interconnecting a safety harness and a lifeline;

FIG. 2 is a front trimetric view of a connector of the safety harness connector assembly shown in FIG. 1 operatively connected to straps of a safety harness;

FIG. 3 is a front trimetric view of the connector shown in FIGS. 1 and 2 and an insert of the safety harness connector assembly shown in FIG. 1;

FIG. 4 is a front trimetric view of the connector shown in FIGS. 1-3, the insert shown in FIG. 3, and a lifeline connector of the safety harness connector assembly shown in FIG. 1;

FIG. 5 is an isometric view of a connector of a safety harness connector assembly constructed in accordance with the principles of the present invention;

FIG. 6 is a top view of the connector shown in FIG. 5;

FIG. 7 is a front view of the connector shown in FIG. 5;

FIG. 8 is a side view of the connector shown in FIG. 5;

FIG. 9 is an isometric view of an insert of a safety harness connector assembly constructed in accordance with the principles of the present invention for use with the connector shown in FIG. 5;

FIG. 10 is a top view of the insert shown in FIG. 9;

FIG. 11 is a front view of the insert shown in FIG. 9; and

FIG. 12 is a side view of the insert shown in FIG. 9.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a modular safety harness connector assembly that can be used with a variety of different lifelines and lanyards, which include a variety of different types of connectors such as but not limited to carabiners, hooks, snap hooks, dual self-retracting lifeline connectors, etc. Therefore, the term “lifeline” is being used to include any suitable lifeline, self-retracting lifeline, lanyard, etc. and the term “connector” is being used to include any suitable connector, carabiner, snap hook, dual self-retracting lifeline connector, etc.

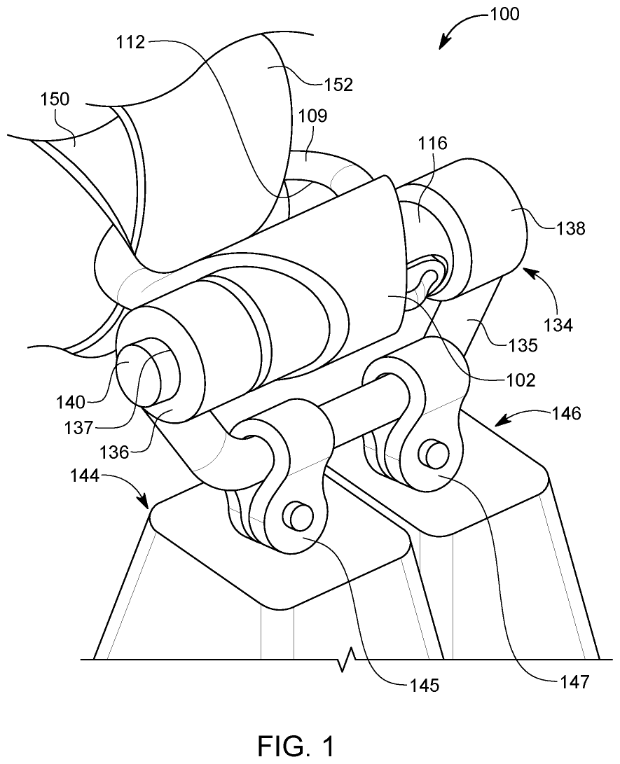

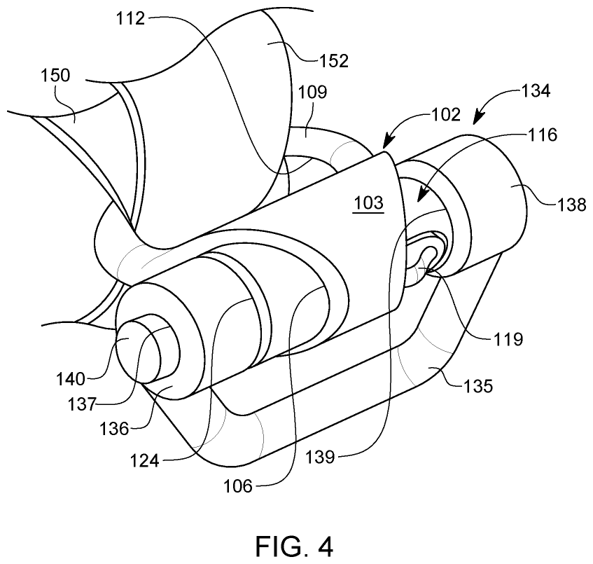

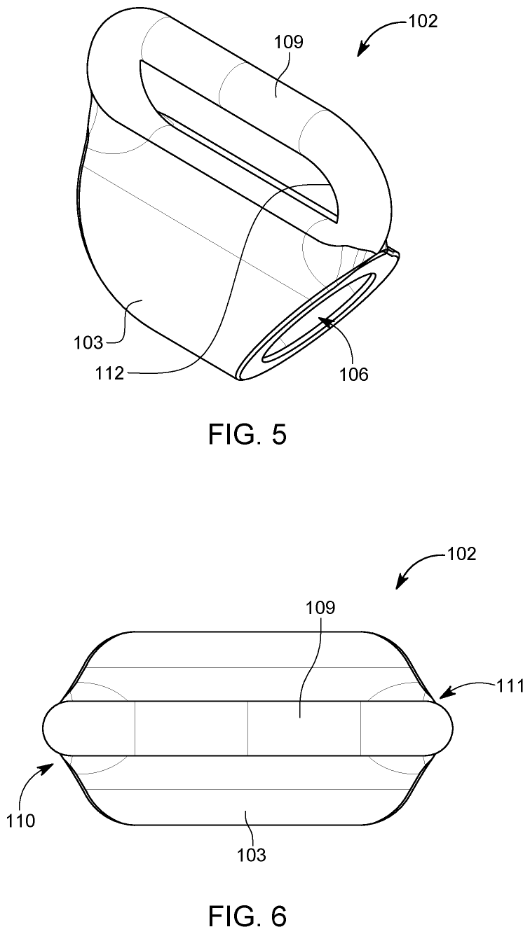

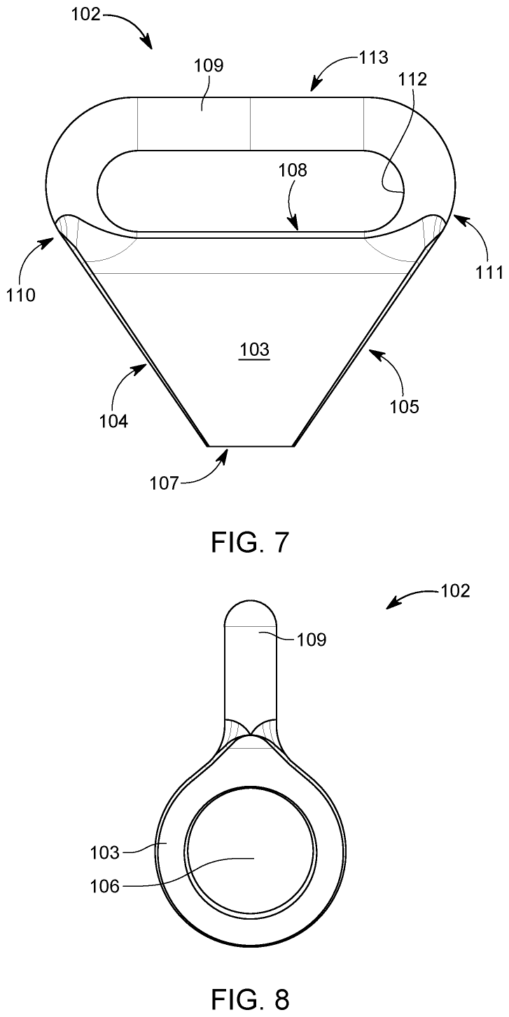

One example safety harness connector assembly 100, shown in FIG. 1, includes a strap connector 102, an optional insert 116, and an optional lifeline connector 134. The strap connector 102, shown in FIGS. 5-8, includes a base 103, which is preferably a cylindrical member having a base bore 106 extending longitudinally through the base 103 from a first side 104 to a second side 105. The base 103 includes a bottom 107 and a top 108. Preferably, the bottom 107 has a bottom length that is shorter than a top length of the top 108 to form first and second angled end surfaces. The first and second angled end surfaces form first and second angled openings into the base bore 106. An extension 109 includes a first side 110 and a second side 111 extending laterally outward from the top 108 of the base 103 and an intermediate portion 113 interconnecting the first and second sides 110 and 111. The extension 109 and the base 103 form an opening 112 configured and arranged to receive a strap of a safety harness (e.g., safety harness straps 150, 152).

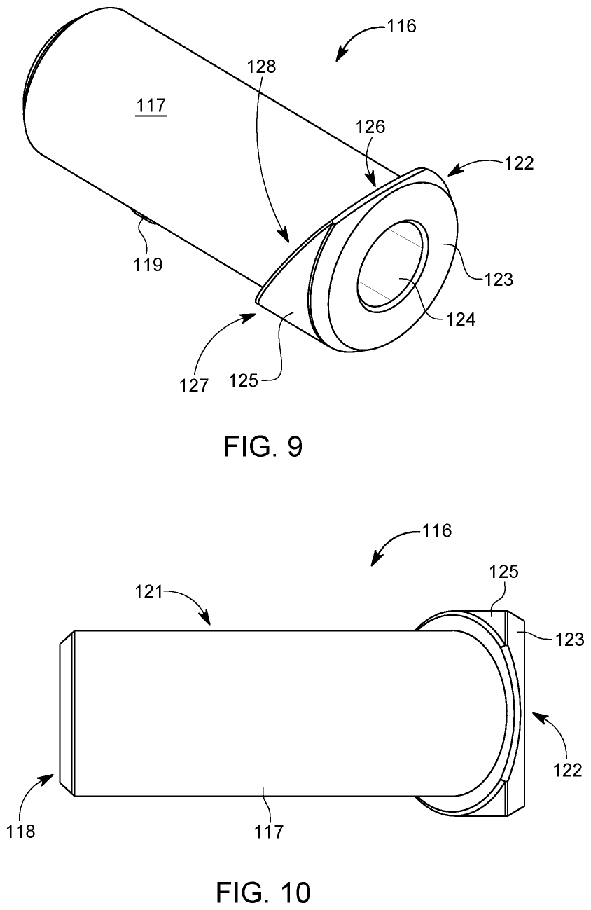

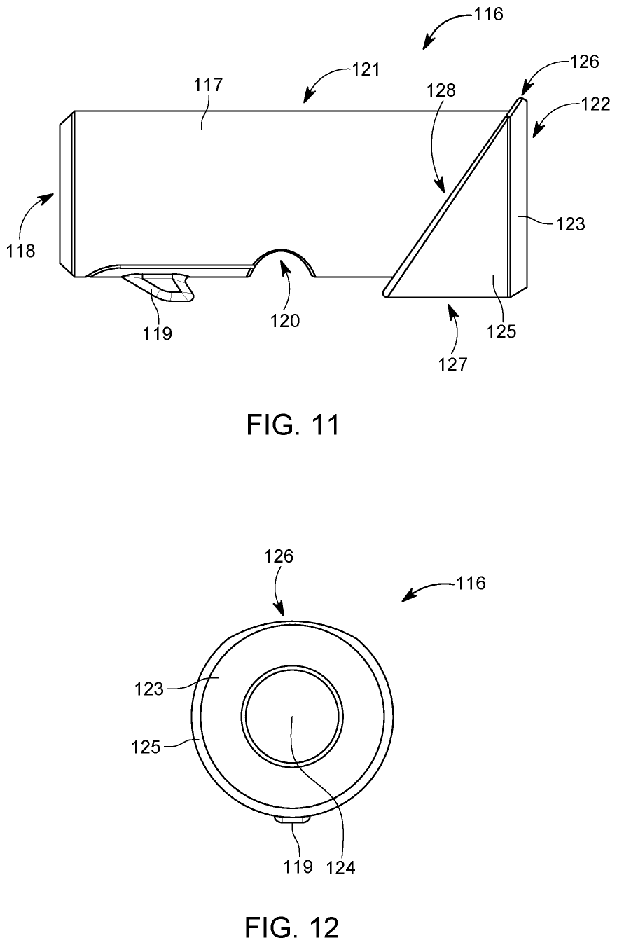

The insert 116, shown in FIGS. 9-12, may be used as a spacer to provide a better fit for a lifeline connector, which could be a lifeline connector 134. It is recognized that an inset could be used with a different type of strap connector, not just the strap connector 102. Preferably, the insert 116 is a cylindrical member having an insert bore 124 extending longitudinally through the insert 116 from a first side 118 to a second side 122. The insert 116 includes a base 117 having an intermediate portion 121 interconnecting the first side 118 and the second side 122. The first side 118 includes a protrusion 119 extending outward from the base 117 between an end of the first side and a notch 120 in the intermediate portion 121. The notch 120 provides a thinner wall thickness so that the face with the protrusion 119 can bend or deflect inward and outward, for example when insert 116 is inserted into strap connector 102 the protrusion 119 is moved inward and when fully inserted the protrusion 119 moves outward thereby securing the insert 116 in place. The second side 122 includes a flange 123 extending outward from the base 117 about the opening into the insert bore 124. A shoulder portion 125 extends from the flange 123 at an angle from a top 126 to a bottom 127 so that the top 126 has a shorter length than the bottom 127 to angle the sides 128.

An example lifeline connector 134 that could be used with the insert 116 includes a generally U-shaped base 135 having a first end 136 with a first end bore 137 and a second end 138 with a second end bore 139. A locking member 140 such as a pin is received within the bores 137 and 138 in a locked position and is moved out of at least one of the bores 137 and 138 in an unlocked position. In the locked position, the locking member 140 engages the baser 135. These types of connectors are well known. The lifeline connector 134 is configured and arranged to connect to a suitable lifeline such as a first self-retracting lifeline 144 and a second self-retracting lifeline 146 via connectors 145 and 147, respectively.

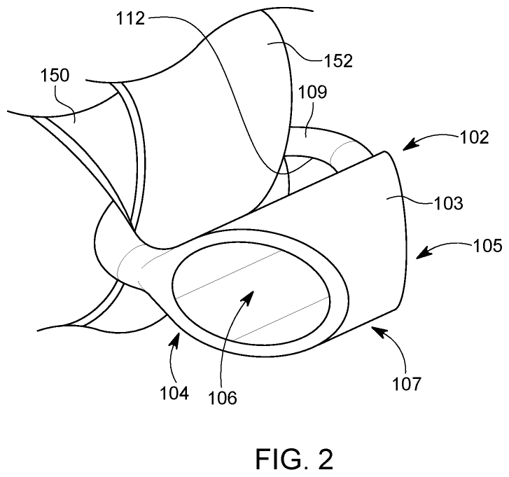

In operation, a strap of a safety harness, for example a first safety harness strap 150 and a second safety harness strap 152 that criss-cross are inserted through the opening 112 of the strap connector 102, as shown in FIG. 2, and then are operatively connected to a dorsal pad assembly (not shown) as is well known in the art. The strap connector 102 could be used alone or it could be used with an optional insert, such as insert 116.

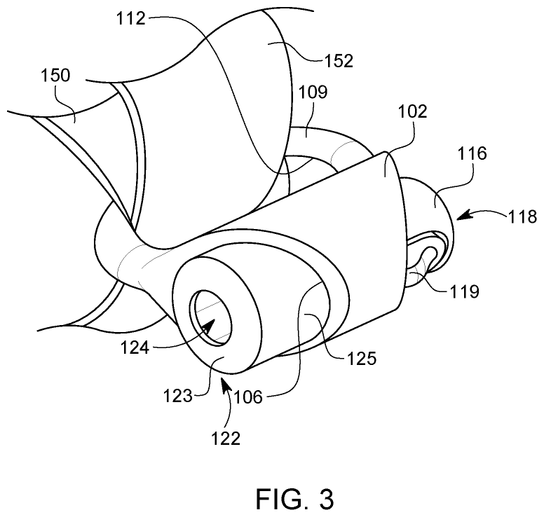

The base bore 106 extending through the base 103 of the connector 102 is configured and arranged to receive each of the insert 116 and a lifeline connector. As shown in FIG. 3, the intermediate portion 121 of the insert 116 is configured and arranged to be received within the base bore 106, and the protrusion 119 and the shoulder portion 125 are configured and arranged to engage opposing ends of the base 103 when the intermediate portion 121 is received within the base bore 106 to secure the insert 116 within the base 103. The protrusion 119 is configured and arranged to deflect between an unlocked positon and a locked position. The unlocked position, when the protrusion 119 is moved inward toward the base 117, allows the insert 116 to be inserted and removed from the base 103. The locked position, when the protrusion 119 is positioned away from the base 117, prevents removal of the insert 116 from the base 103. Preferably, the shoulder portion 125 and the base 103 have mating angled surfaces. The shoulder portion 125 is configured and arranged to engage with the corresponding surface of the strap connector 102 to stabilize the insert 116 relative to the strap connector 102. Preferably, the protrusion 119 and the shoulder portion 125 engage the base 103 proximate the bottom 107 of the base 103, or where it is narrower. The insert 116 does not need to maintain its structural integrity should a force be exerted on it, for example during a fall. Therefore, the insert 116 could be molded from plastic or any other suitable material.

The insert bore 124 extending through the base 117 of the insert 116 is configured and arranged to receive a lifeline connector, such as lifeline connector 134, as shown in FIG. 4. Preferably, the corresponding ends of the insert 116 and the lifeline connector 134 mate or engage to stabilize the lifeline connector 134 relative to the strap connector 102.

The strap connector 102 is modular because it could be used with a lifeline connector (e.g., carabiner, snap hook, dual self-retracting lifeline connector, etc.) or an insert, and the insert could be configured and arranged to be used with any suitable lifeline connector.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A safety harness connector assembly, comprising:
a strap connector including a base through which a base bore longitudinally extends and an extension, the base and the extension forming an opening configured and arranged to receive a strap of a safety harness; and
an insert including an intermediate portion interconnecting a first side and a second side, the intermediate portion configured and arranged to be received within the base bore, the first side including a protrusion and the second side including a shoulder portion, the protrusion and the shoulder portion configured and arranged to engage opposing ends of the base when the intermediate portion is received within the base bore to secure the insert within the base.

2. The safety harness connector assembly of claim 1, wherein the protrusion is configured and arranged to deflect between an unlocked position and a locked position, wherein the unlocked position allows the insert to be inserted and removed from the base and the locked position prevents removal of the insert from the base.

3. The safety harness connector assembly of claim 1, wherein the base and the shoulder have mating angled surfaces.

4. The safety harness connector assembly of claim 1, wherein the base includes a top having a top length and a bottom having a bottom length, the top length being longer than the bottom length.

5. The safety harness connector assembly of claim 4, wherein the top length and the bottom length form first and second angled end surfaces of the base.

6. The safety harness connector assembly of claim 5, wherein the protrusion and the shoulder portion engage the base proximate the bottom of the base.

7. The safety harness connector assembly of claim 1, wherein the insert includes an insert bore configured and arranged to receive a lifeline connector.

8. A safety harness, comprising:
a strap forming at least a portion of the safety harness; and
a strap connector including a base through which a base bore longitudinally extends and an extension extending laterally outward from a top of the base, the base and the extension forming an opening through which the strap extends, the top of the base being longer in length than a bottom of the base and forming a first angled end surface and a second angled end surface, the first angled end surface forming a first angled opening into the base bore and the second angled end surface forming a second angled opening into the base bore.

9. The safety harness of claim 8, further comprising an insert including an intermediate portion interconnecting a first side and a second side, the intermediate portion configured and arranged to be received within the base bore, the first side including a protrusion and the second side including a shoulder portion, the protrusion and the shoulder portion configured and arranged to engage opposing ends of the base when the intermediate portion is received within the base bore to secure the insert within the base.

10. The safety harness connector assembly of claim 9, wherein the protrusion is configured and arranged to deflect between an unlocked position and a locked position, wherein the unlocked position allows the insert to be inserted and removed from the base and the locked position prevents removal of the insert from the base.

11. The safety harness connector assembly of claim 9, wherein the base and the shoulder have mating angled surfaces.

12. The safety harness connector assembly of claim 8, wherein the base includes a top having a top length and a bottom having a bottom length, the top length being longer than the bottom length.

13. The safety harness connector assembly of claim 8, wherein the top length and the bottom length form first and second angled end surfaces of the base.

14. The safety harness connector assembly of claim 9, wherein the base includes a top having a top length and a bottom having a bottom length, the top length being longer than the bottom length, and wherein the protrusion and the shoulder portion engage the base proximate the bottom of the base.

15. The safety harness connector assembly of claim 9, wherein the insert includes an insert bore configured and arranged to receive a lifeline connector.

16. An insert for use with a strap connector having a base with a base bore, comprising: an intermediate portion interconnecting a first side and a second side, the intermediate portion configured and arranged to be received within the base bore, the first side including a protrusion and the second side including a shoulder portion, the protrusion and the shoulder portion configured and arranged to engage opposing ends of the base when the intermediate portion is received within the base bore to secure the insert within the base.

17. The insert of claim 16, wherein the protrusion is configured and arranged to deflect between an unlocked position and a locked position, wherein the unlocked position allows the insert to be inserted and removed from the base and the locked position prevents removal of the insert from the base.

18. The insert of claim 16, wherein the insert includes an insert bore configured and arranged to receive a lifeline connector.
